(19) United States
(12) Patent Application Publication
(10) Pub. No.: US 2026/0356078 A1
(43) Pub. Date: Nov. 12, 2026

(54) CONTINUOUS SHEETS OF FIBER MATERIAL AND ASSOCIATED METHODS

(71) Applicant: Northrop Grumman Systems Corporation, Falls Church, VA (US)

(72) Inventors: Mia Weintraub, Salt Lake City, UT (US); Christopher J. Madsen, Layton, UT (US); Vernon M. Benson, Morgan, UT (US)

(21) Appl. No.: 19/201,718

(22) Filed: May 7, 2025

(51) Int. Cl. B32B 7/12; B32B 5/06; B32B 5/12; B32B 37/06; B32B 37/10; B32B 37/12

(52) U.S. Cl. CPC B32B 7/12; B32B 5/073; B32B 5/12; B32B 37/06; B32B 37/10; B32B 37/1284; B32B 2307/516; B32B 2307/7375

(57) ABSTRACT

A continuous sheet of fiber material includes a first segment of fiber material, a second segment of fiber material, and a joint between the first segment of fiber material and the second segment of fiber material. The continuous sheet of fiber material may include a seaming material extending across the joint between the first segment of fiber material and the second segment of fiber material. The seaming material includes reinforcing fibers and a binder material. The binder material is at least partially embedded into fibers of the first segment of fiber material and the second segment of fiber material. In another embodiment, the continuous sheet of dry-fiber material includes stitches extending across the joint between the first segment of fiber material and the second segment of fiber material.

### TECHNICAL FIELD

Embodiments of the disclosure generally relate to continuous sheets of fiber material. In particular, embodiments of the disclosure relate to continuous sheets of fiber material, continuous rolls of fiber materials, methods of forming the continuous sheets of fiber material, and associated systems and methods.

### BACKGROUND

In the formation of composite laminate structures, layers of fiber materials such as dry-fiber or pre-impregnated fiber material (pre-preg) are typically laid up over each other. A resin or matrix may be added to the dry-fiber prior to, during, or after the layup process. Typically, a small amount of resin or matrix is added to the dry-fiber by a material supplier to stabilize the individual fiber bundles into a format that can be handled for layup. This stabilizing resin addition can be in the form of a light weight resin veil, powderized resin binder, stitching thread material, co-mingled yarns, or some combination of these or other means. With the dry-fiber materials in a handleable format they can be laid-up into multi-ply lamainates.

After the layup process, resin or matrix is addedto surround all the individual fibers and the laminate is heat set (cured or fused) to form the composite laminate structure. Composite materials are made of reinforcing fibers such as carbon, glass, aramid, and the like, which are bonded together with a resin system. Often, to achieve a desired laminate characteristic, the plies of composite materials are layered with their fibers having different orientations in relation to each other to tailor the laminate's structural properties. For example, in applications for forming high strength, low weight complex shaped structures, it may be desired to apply and form one layer of the composite material at a time on a tool with one or more of the different layers having different fiber orientations than another layer. However, fiber materials are typically only supplied by a manufacturer as 0° fabric or tape (with all its fibers orientated in one direction in relation to an edge of the fiber material roll) or 0/90 fabric (continuous fiber in the roll-up direction, 0°, with discontinuous woven or stitched fibers running transverse to the roll-up direction, 90°). A more recent alternative dry-fiber material format is a non-crimp fabric (NCF), where multiple layers of fibers are stacked at different orientations and stitched together. These NCFs generally involve some combination of light resin content, such as veils, binders, stitching, co-mingled yarns, etc. as previously mentioned.

### BRIEF SUMMARY

Embodiments of the disclosure includes a continuous sheet of fiber material. The continuous sheet of fiber material includes a first segment of fiber material, a second segment of fiber material, and a joint between the first segment of fiber material and the second segment of fiber material. The continuous sheet of fiber material further includes a seaming material extending across the joint between the first segment of fiber material and the second segment of fiber material. The seaming material includes reinforcing fibers and a binder material. The binder material is at least partially embedded into fibers of the first segment of fiber material and the second segment of fiber material.

Other embodiments of the disclosure include a continuous sheet of dry-fiber. The continuous sheet of dry-fiber includes a first segment of dry-fiber material including a first plurality of fibers. The continuous sheet of dry-fiber further includes a second segment of dry-fiber material including a second plurality of fibers. The continuous sheet of dry-fiber also includes a joint between the first segment of dry-fiber material and the second segment of dry-fiber material. The joint is substantially parallel with the first plurality of fibers in the first segment of dry-fiber material and the second plurality of fibers in the second segment of dry-fiber material. The continuous sheet of dry-fiber material further includes stitches extending across the joint between the first segment of dry-fiber material and the second segment of dry-fiber material. The stitches are formed from at least one fiber, each stitch of the stitches extending in a direction substantially perpendicular to the joint.

Another embodiment of the disclosure includes a method of forming a continuous sheet of fiber material. The method includes positioning a feedstock material having no backing material at an angle relative to an output axis. The method further includes cutting a segment of the feedstock material. The method also includes attaching the segment of the feedstock material to an output material at the angle relative to the output axis, the outlet material having no backing material.

### BRIEF DESCRIPTION OF THE DRAWINGS

While the specification concludes with claims particularly pointing out and distinctly claiming embodiments of the disclosure, the advantages of embodiments of the disclosure may be more readily ascertained from the following description of embodiments of the disclosure when read in conjunction with the accompanying drawings in which:

FIG. 1 is a side perspective view of a material preparation device according to embodiments of the disclosure;

FIG. 2 is a simplified top view of the material preparation device of FIG. 1 illustrating different exemplary orientations of the components of the material preparation device;

FIG. 3 illustrates a schematic view of a manufacturing head in accordance with embodiments of the disclosure;

FIG. 4 illustrates a continuous sheet or roll of fiber material in accordance with embodiments of the disclosure;

FIGS. 5A and 5B illustrate schematic views of embodiments of a joint between two segments of fiber material in a continuous sheet or roll of fiber material in accordance with embodiments of the disclosure;

FIG. 6 illustrates a sewing head 600 in accordance with embodiments of the disclosure;

FIG. 7 illustrates a continuous sheet or roll of fiber material in accordance with embodiments of the disclosure;

FIGS. 8A and 8B illustrate schematic views of embodiments of a joint between two segments of fiber material in a continuous sheet or roll of fiber material in accordance with embodiments of the disclosure;

FIGS. 9A through 9C illustrate schematic views of embodiments of a joint between two segments of fiber material in a continuous sheet or roll of fiber material in accordance with embodiments of the disclosure;

FIG. 10 illustrates a side perspective view of the embodiment of the material preparation device of FIG. 1 coupled to a slitter device in accordance with embodiments of the disclosure; and

FIG. 11 illustrates a flow chart representative of a method of forming a sheet or roll of continuous fiber material in accordance with embodiments of the disclosure.

### DETAILED DESCRIPTION

The following description provides specific details, such as material compositions, shapes, and sizes, in order to provide a thorough description of embodiments of the disclosure. However, a person of ordinary skill in the art would understand that the embodiments of the disclosure may be practiced without employing these specific details. Indeed, the embodiments of the disclosure may be practiced in conjunction with conventional techniques employed in the industry.

Drawings presented herein are for illustrative purposes only and are not meant to be actual views of any particular material, component, structure, device, or system. Variations from the shapes depicted in the drawings as a result, for example, of manufacturing techniques and/or tolerances, are to be expected. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale. Additionally, elements common between figures may retain the same numerical designation.

As used herein, the term “substantially” in reference to a given parameter means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, relational terms, such as “beneath,” “below,” “lower,” “bottom,” “above,” “upper,” “top,” “lead,” “leading,” “trailing,” “left,” “right,” and the like, may be used for ease of description to describe one element's or feature's relationship to another element(s) or feature(s) as illustrated in the drawings. Unless otherwise specified, the spatially relative terms are intended to encompass different orientations of the materials in addition to the orientation depicted in the figures. For example, if materials in the figures are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the terms “vertical,” “longitudinal,” “horizontal,” and “lateral” are in reference to a major plane of a structure and are not necessarily defined by earth's gravitational field. A “horizontal” or “lateral” direction is a direction that is substantially parallel to the major plane of the structure, while a “vertical” or “longitudinal” direction is a direction that is substantially perpendicular to the major plane of the structure. The major plane of the structure is defined by a surface of the structure having a relatively large area compared to other surfaces of the structure. With reference to the drawings, a “horizontal” or “lateral” direction may be perpendicular to an indicated “Z” axis, and may be parallel to an indicated “X” axis and/or parallel to an indicated “Y” axis; and a “vertical” or “longitudinal” direction may be parallel to an indicated “Z” axis, may be perpendicular to an indicated “X” axis, and may be perpendicular to an indicated “Y” axis.

As used herein, the singular forms “a,” “an,” and “the” are intended to include the plural forms as well, unless the context clearly indicates otherwise.

As used herein, the term “and/or” means and includes any and all combinations of one or more of the associated listed items.

As used herein, the term “pre-preg” means and includes a fiber material, such as a fiber tow or fiber sheet, that is pre-impregnated with resin.

As used herein, the term “dry-fiber” means and includes a fiber material, such as a fiber tow or fiber sheet, that is substantially free of a matrix material (e.g., resin), but may contain some small amount of resin in the form of a powder or veil or stitching or co-mingled yarn, etc.

Fiber materials are typically supplied by a manufacturer as 0° fabric or tape, which includes all its fibers orientated in one direction in relation to an edge of the fiber material roll (e.g., 0° or 90° relative to the edge of the fiber material roll) or 0/90 fabric, which includes continuous fiber in the roll-up direction (0°) and discontinuous woven or stitched fibers running transverse to the roll-up direction, (90°). A more recent alternative dry-fiber material format is a non-crimp fabric (NCF), where multiple layers of fibers are stacked at different orientations and stitched together. These NCFs generally involve some combination of light resin content, such as veils, binders, stitching, co-mingled yarns, etc. as previously mentioned. To achieve other fiber orientations in a composite structure, such as for desired stacking sequences, it is desirable to have an efficient method of forming supply rolls of the fiber material with different fiber orientations (e.g., bias ply fiber material rolls) and combinations of orientations. Forming fiber material supply rolls with different fiber orientations facilitates successive layers or combinations of layers of fiber material being applied (e.g., automatically applied through automated machinery) and formed into structural shapes with layers having different fiber orientations in desired stacking sequences. Examples of common orientations, besides 0 degree and 0/90 degree, which are used in a continuous roll format include, but are not limited to, 30°, 45°, 60°, 90°, 120°, 135°, and 130°. Combinations of these are also used, including but not limited to, 45°/135°, 60°/130°, 0°/90°, 30°/120°, 30°/90°/120°, 0°/90°/45°/145°, etc.

Embodiments of the disclosure provide devices and methods that create (e.g., automatically create, through automated machinery) fiber material rolls having preselect fiber orientations (e.g., 30°, 45°, 60°, 90°, 120°, 135°, and 130°) or combinations of orientations in a programmed sequence (e.g., 30/90/120, 45/135, 45/0/135/90, etc.) from a manufactured fiber material supply roll (such as 0° uni-directional fabric or tape or 0/90 fabric) where the select fiber orientations of the created fiber material rolls are different from the fiber orientations of the manufactured fiber material supply roll.

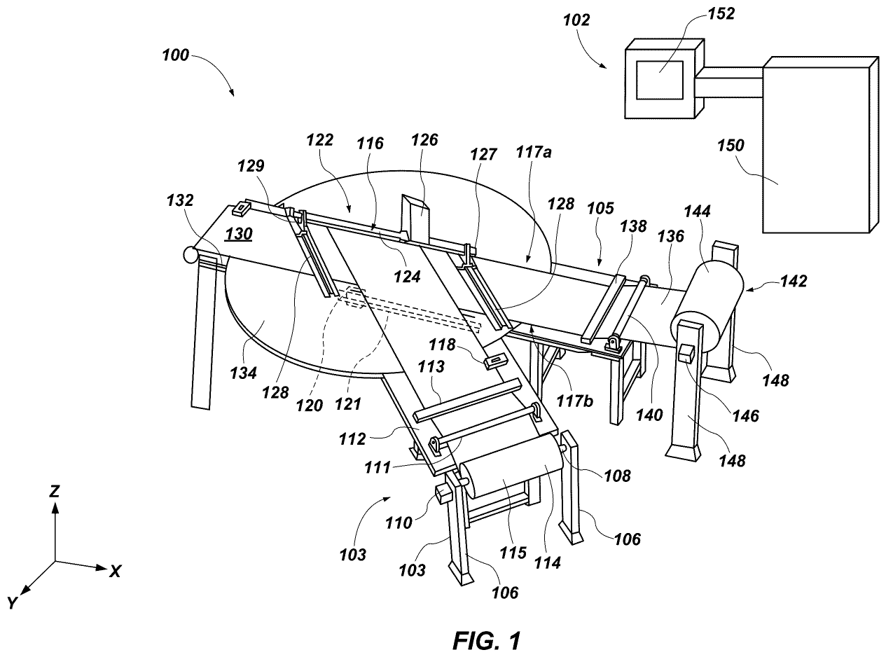

A material preparation device 100 according to embodiments of the disclosure is illustrated in FIG. 1. The material preparation device 100 includes a control system 102 that controls operations of the material preparation device 100. The material preparation device 100 also includes a feedstock assembly 103 and an outlet assembly 105. The feedstock assembly 103 includes a roll of feedstock material 115, such as uni-directional fabric or tape or 0/90 fabric material. Unidirectional feedstock material 115 includes fibers that are typically oriented at 0° to an edge of material (e.g., parallel with the edge of the roll). The feedstock material 115 may or may not have a backing material. An output material 136 is formed on an outlet support structure 130. The output material 136 is formed by cutting the feedstock material 115 into segments as it is placed on the outlet support structure 130, where the feedstock material 115 is oriented at a desired angle relative to the path of the outlet support structure 130. The angle of the feedstock material 115 relative to the path of the outlet support structure 130 defines an orientation of the fibers in the output material 136. The segments of the feedstock material 115 are then attached to adjacent segments of the feedstock material 115 to form a continuous output material 136. Thus, the output material 136 has a select orientation relating to the orientation of the fibers in the output material 136 such as but not limited to 30°, 45°, 60°, 90°, 120°, 135°, and 150°. The output material 136 may be formed as a single bias-ply having its fibers at the select orientation or may involve more than one layer at different orientations or combinations of orientations in a programmed sequence (e.g., 30/90/120, 45/135, 45/0/135/90, etc.) using multiple 103 feedstock assemblies or running the output roll back through a single feedstock assembly. The output material 136 may or may not have a backing material.

The feedstock assembly 103 includes feedstock supports 106 and a feedstock unwind chuck 108 rotationally attached between the feedstock supports 106. A tension motor 110 is coupled to the feedstock unwind chuck 108 and is configured to control the rotation of the feedstock unwind chuck 108. A feedstock roll 114 including a roll of feedstock material 115 is mounted on the feedstock unwind chuck 108. The feedstock material 115 is threaded between rollers 111 that may be driven by a servo motor. A guide 113 is coupled to a feedstock support table 112. The feedstock material 115 passes through guide 113. A sensor 118 senses the alignment of the feedstock material 115 and is in communication with a controller 150 of the control system 102. The controller 150 of the control system 102 may also include a user interface 152 configured to provide information to a user and/or receive input from a user, such as to begin a process, end a process, modify a process, etc. The feedstock material 115 is captured by an application head 122. The application head 122 includes an application shoe 124 and an attachment device 126 that are retained between brackets 127. Ends of the application shoes 124 are received in respective slots 129 of retaining brackets 127. The slots 129 may facilitate the application shoe 124 moving in a vertical direction. The retaining brackets 127 are slidably coupled to cross travel tracks 128. This sliding connection facilitates movement of the brackets 127, the application shoe 124 and the attachment device 126 horizontally across a width of the outlet support structure 130.

In some embodiments, the application head 122 is configured to pull the feedstock material 115 across the outlet support structure 130 to align an end 116 of the feedstock material 115 with a first edge 117a of the output material 136. For example, the application shoe 124 may be configured to capture the end 116 of the feedstock material 115 in an area proximate a second edge 117b of the output material 136 opposite the first edge 117a of the output material 136. The application shoe 124 may then pull the feedstock material 115 across the outlet support structure 130 as the application head 122 moves across the outlet support structure 130 along the cross-travel tracks 128. As the application shoe 124 pulls the feedstock material 115 across the outlet support structure 130, the tension motor 110 may maintain tension on the feedstock unwind chuck 108 and the feedstock roll 114. The tension in the feedstock roll 114 may maintain a substantially constant tension in the feedstock material 115 across a length of the feedstock support table 112. The feedstock material 115 passes through the set of rollers 111 and the guide 113 after exiting the feedstock roll 114 and before reaching the second edge 117b of the output material 136. The guide 113 and the rollers 111 may be configured to maintain the feedstock material 115 in a substantially flat orientation relative to the feedstock support table 112.

Once the end 116 of the feedstock material 115 is aligned with the first edge 117a of the output material 136, the segment of the feedstock material 115 is attached to the output material 136 by the attachment device 126. The attachment device 126 may be a seaming head including a veil, binder, or permeable tape type material configured to attach the segment of the feedstock material 115 to the output material 136, a stitching head configured to stitch or sew the segment of the feedstock material 115 to the output material 136, or a welding device configured to weld a thermoplastic tape or vale to connect the segments 402. The welding device may use, heat transfer, joule heating, ultrasonic heating, induction, radian, heating etc. In some embodiments, the attachment device 126 is positioned to attach the segment of the feedstock material 115 to the output material 136 while the segment of the feedstock material 115 remains aligned with the feedstock material 115.

The material preparation device 100 also includes a cutter 120 that works in conjunction with the application head 122 to cut the feedstock material 115. The cutter 120 is slidably coupled to a cutting track 121 such that the cutter 120 cuts across a width of the feedstock material 115. In one embodiment, the cutter 120 is a scribe cutter. The cutter 120 and the cutting track 121 are substantially aligned with the second edge 117b of the output material 136, such that once each segment of the feedstock material 115 is cut by the cutter 120, the cut end of the feedstock material 115 forms the second edge 117b of the output material 136 for the associated segment.

After the segment of the feedstock material 115 is separated from the feedstock material 115 (e.g. supply material or supply roll) and attached to the output material 136, the output material 136 may move along the outlet support structure 130 to facilitate attaching another segment of the feedstock material 115 to the output material 136. In some embodiments, the output material 136 is moved by an output material gathering assembly 142. The output material gathering assembly 142 includes a roll 144 supported between two supports 148. The roll 144 is coupled to a tension motor 146. The tension motor 146 is configured to rotate the roll 144 drawing the output material 136 to the roll 144. The output material 136 may pass through a guide 138 and a set of rollers 140 before reaching the roll 144. The guide 138 and the rollers 140 may maintain the output material 136 in a substantially flat orientation as the output material 136 moves along the outlet support structure 130. In some embodiments, the outlet support structure 130 may be configured to move in the traveling direction of the output material 136, such as to assist the movement of the output material 136 after each segment of the feedstock material 115 is attached to the output material 136 and separated from the feedstock material 115.

In some embodiments, the segment of the feedstock material 115 may move with the output material 136 before being attached to the output material, such as through the movement of the outlet support structure 130, a conveyor belt, or a clamp temporarily coupling the segment to the output material 136. The segment of the feedstock material 115 may then be attached to the outlet material 136 by the attachment device 126 in embodiments where the attachment device 126 is positioned between location of the feedstock material 115 and the roll 144. In other embodiments, the material preparation device 100 may include multiple attachment devices 126 positioned along the path between the location of the feedstock material 115 and the roll 144.

The material preparation device 100 forms an output material 136 having fibers at a select orientation from a 0° fiber orientation feedstock material 115. In this example embodiment, the select orientation of the output material 136 is determined by the angle in which a path of the feedstock material 115 of the feedstock assembly 103 crosses a path of the outlet support structure 130 and the output material 136 of the outlet assembly 105. In other embodiments, where the feedstock material 115 does not have a 0° fiber orientation, the orientation of the fibers in the formed output material 136 is determined by taking into consideration the fiber orientation in the feedstock material 115 and the angle between the two paths. In the embodiment of FIG. 1, a round base support 134 is coupled to support table 132 of the outlet assembly 105. The feedstock assembly 103 is rotationally coupled to the round base support 134. Thus, the orientation of the feedstock assembly 103 can be changed in relation to the outlet assembly 105.

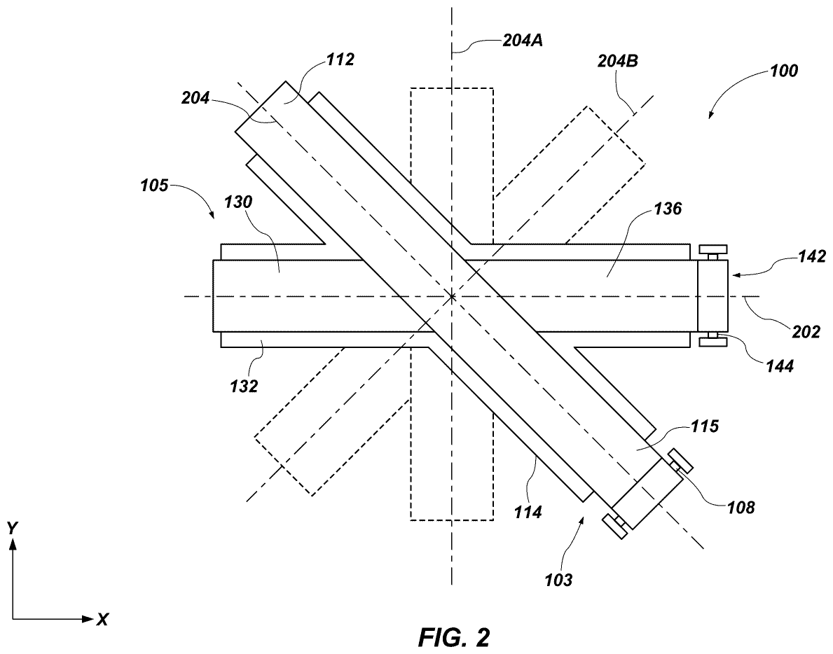

FIG. 2 illustrates a simplified top view of the material preparation device 100. The outlet assembly 105 is positioned along output axis 202. The feedstock assembly 103 is positioned along input axis 204. The input axis 204 is positioned at a select angle α in relation to output axis 202 of the outlet assembly 105. Thus, if the feedstock material 115 has fibers at a 0° orientation, the resulting orientation of the fibers in the formed output material 136 will be angle α. In some embodiments, angle α is adjusted by rotating the feedstock assembly 103 in relation to the outlet assembly 105, as illustrated in FIG. 2. In other embodiments, the outlet assembly 105 may be rotated relative to the feedstock assembly 103 to change the angle α. Different angles α that achieve different ply orientations in the output material 136 as indicated by exemplary input axes 204A and 204B are possible. Example angles α include about 45° between the output axis 202 and the feedstock input axis 204, about 90° between output axis 202 and feedstock input axis 204 (e.g., input axis 204A) and about 135° between output axis 202 and feedstock input axis 204 (e.g., input axis 204B). The above values for angle α are exemplary and non-limiting, angle α may be any angle between 0° and 180°, such as any angle between about 17.5° and about 172.5°.

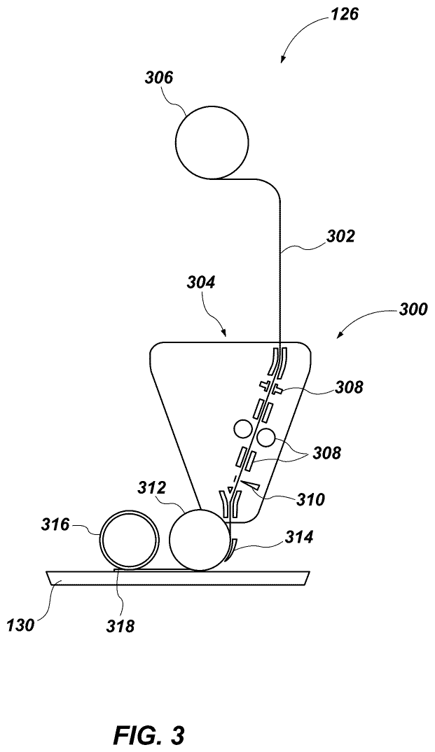

FIG. 3 illustrates an embodiment of the attachment device 126 of the application head 122. The attachment device 126 may be a manufacturing head 300. The manufacturing head 300 is configured to receive a seaming material 302 from a spool 306. The seaming material 302 may be a fiber reinforced material including a resin binder, a resin veil material, or other binding medium compatible with the dry fiber formats being bound together. The automated manufacturing head 300 includes a dispensing device 304 configured to feed the seaming material 302 onto the fiber material 318. The dispensing device 304 is configured to apply the seaming material 302 over a seam between segments of the fiber material 318 (e.g., the segments of the feedstock material 115 (FIG. 1)).

In some embodiments, the seaming material 302 is reinforced with fibers or threads. For example, the seaming material 302 may be formed with embedded fibers or threads running transverse to a length of the seaming material 302. In other embodiments, the fibers may be applied across the joint between the two segments of the fiber material 318 before the seaming material 302 and the seaming material 302 may then be applied over the fibers. The fibers or threads in the associated seaming material 302 may include without limitation, glass fibers, carbon and graphite fibers, cotton thread, basalt fibers, polymeric fibers, including aramide and boron filaments, silica fibers, copper fibers and the like. The fibers may be non-conductive or conductive, depending upon the desired application of the resulting composite structure. The seaming material 302 may also include a binder or veil, such as a resin or matrix material. For example, the binder may be a thermoset polymer material, an acrylic resin, a polyester resin, a vinyl ester resin, thermoplastic resin, or an epoxy resin including a single component of a multi-component resin.

The automated manufacturing head 300 includes one or more clamping, feeding and guide components 308 and one or more cutting components 310 disposed in feed-through positioning with at least one compaction roller 312, configured to deliver a force to adhere the seaming material 302 to the fiber material 318. The automated manufacturing head 300 may also include a tow guide scoop 314 configured to guide the seaming material 302 onto the fiber material 318. The manufacturing head 300 also includes a heating element 316 configured to apply a pressure and heat the seaming material 302 as it is applied to the fiber material 318. The heating element 316 may be a heated roller, an ironing roller, or other heated component configured to apply a pressure and heat to the seaming material 302. The heating element 316 may cause the binder of the seaming material 302 to bond with the fiber material 318 on either side of the seam between the segments of the fiber material 318. Thus, the seaming material 302 may secure or bind the two segments of the fiber material 318 together. The fiber reinforcement in or under the seaming material 302 is configured to increase a strength of the joint between the segments of the fiber material 318.

As discussed above, the manufacturing head 300 may be mounted to the application head 122. In other embodiments, the automated manufacturing head 300 may be mounted on a robotic head (not shown) configured to operate independently of the application head 122.

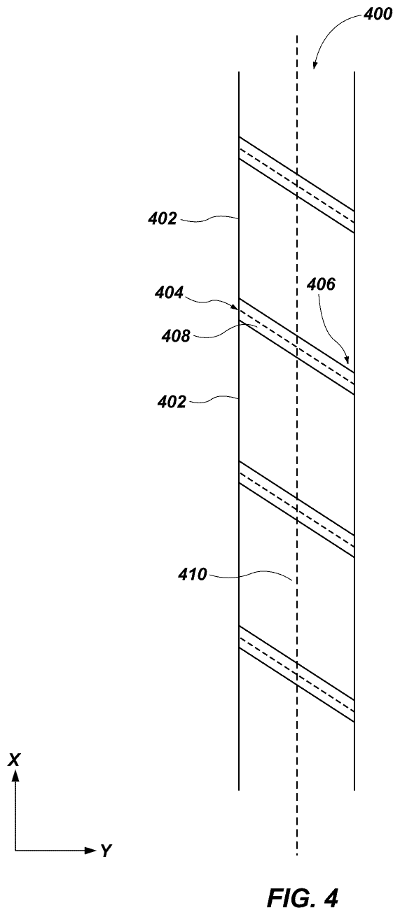

FIG. 4 illustrates a continuous sheet of fiber material 400 that may be formed by the material preparation device 100 (FIG. 1) including the manufacturing head 300 (FIG. 3). The continuous sheet of fiber material 400 includes segments 402 joined together at joints 404. As discussed above, the segments 402 are formed from a feedstock material 115 (FIG. 1) that may have a 0° fiber orientation. The segments 402 are formed with the feedstock material 115 (FIG. 1) extending at an angle 406 relative to a material axis 410 of the continuous sheet of fiber material 400. Thus, when the feedstock material 115 (FIG. 1) has a 0° fiber orientation, the fiber orientation of the continuous sheet of fiber material 400 is the angle 406 between the feedstock material 115 (FIG. 1) and the material axis 410.

The segments 402 may be joined together by a seaming material 408 extending along the joint 404. As discussed above, the seaming material 408 may be a fiber reinforced material, such as a low areal weight fiber with binder or resin veil, an unreinforced resin veil material, comingled resin and fiber filaments, or other binder compatible with the dry material format. The seaming material 408 may be configured to form bonds with the underlying material of the segments 402. For example, when heated, the binder in the seaming material 408 may diffuse into the fibers of the underlying segments 402 bonding the segments 402 to the seaming material 408. The seaming material 408 may be heated with a heating element configured to apply heat and pressure to the seaming material 408, such as the heating element 316 illustrated in the manufacturing head 300 of FIG. 3.

The seaming material 408 may include fibers, such as carbon fibers, glass fibers, various light weight thread materials, resin veil materials, etc., extending across the joint 404. The fibers may be configured to reinforce the seaming material 408 across the joint 404. In some embodiments, the fibers extend in a direction substantially perpendicular to the joint 404, such that the fibers form a 90° angle with the joint 404. In other embodiments, the fibers extend in a direction substantially parallel with the material axis 410. In some embodiments, segments 402 may be overlapped with a binder or seaming material applied in-between the overlapped area.

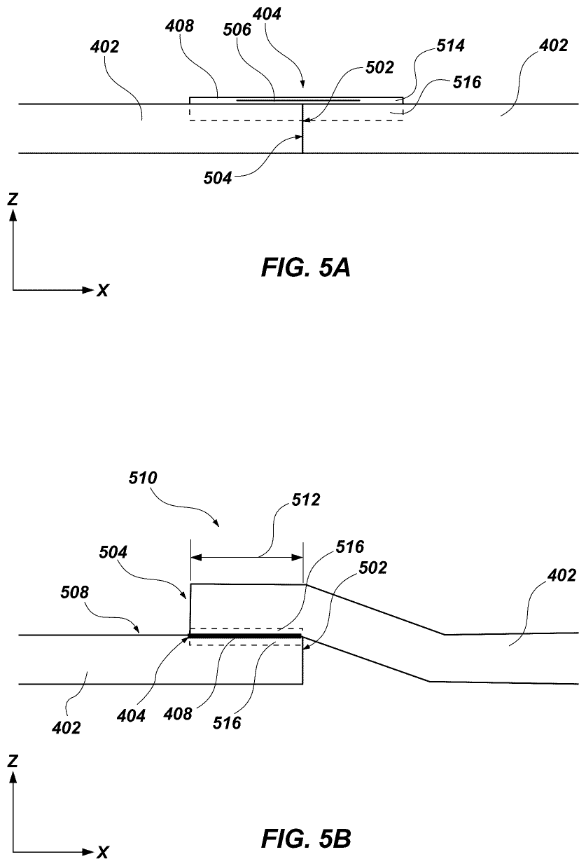

FIGS. 5A and 5B illustrate different embodiments for the joint 404 between adjacent segments 402. In FIGS. 5A and 5B, the dimensions are exaggerated for illustrative purposes. In some embodiments, the joint 404 is a butt joint with no overlap between the adjoining segments 402 as illustrated in FIG. 5A. In other embodiments, the joint 404 is a partially overlapped joint where a portion of the adjoining segments 402 overlap each other at the joint 404 as illustrated in FIG. 5B.

FIG. 5A illustrates a butt joint between two segments 402. At the joint 404 between the two segments 402, a first lateral edge 502 of a first segment 402 abuts a second lateral edge 504 of a second segment 402 with substantially no gap defined between the first lateral edge 502 and the second lateral edge 504. As discussed above, the first segment 402 and the second segment 402 may be joined together by a seaming material 408 spanning the joint 404 between the two segments 402.

The seaming material 408 may be reinforced with fibers 506 extending in a direction transverse to the joint 404. The fibers 506 extend across the joint 404, such that each of the fibers 506 extends over a portion of the horizontal area of each of the segments 402. Thus, the fibers 506 may be configured to reinforce the joint 404 between the segments 402. The fibers 506 may include, without limitation, glass fibers, carbon and graphite fibers, basalt fibers, polymeric fibers, including aramide and boron filaments, silica fibers, copper fibers, light weight threads, comingled resin and structural fibers, and the like.

As discussed above, the seaming material 408 may be formulated to form bonds with the underlying material of the segments 402 when heated. For example, when heated, a binder 514 of the seaming material 408 may diffuse into the fibers of the underlying segments 402 creating an embedded binder 516 (indicated by the dashed line) that is adhered to the fibers of the segments 402. The embedded binder 516 effectively binds the fibers of the segments 402 to the seaming material 408. The seaming material 408 and the fibers 506 extend across the joint 404 between the segments 402, such that the embedded binder 516 on each side of the joint 404 operatively couples the fibers of the segments 402 to each other through the seaming material 408 and the associated fibers 506. Coupling the segments 402 across the joint 404 between the segments 402 with the seaming material 408 and/or the fibers 506 may facilitate joining the segments 402 without a backing material.

FIG. 5B illustrates an overlapping joint between two segments 402. In the embodiment illustrated in FIG. 5B, the second lateral edge 504 extends past the first lateral edge 502, such that the second segment 402 extends over a portion of an upper surface 508 of the first segment 402. An overlap region 510 is defined between the first lateral edge 502 and the second lateral edge 504. The overlap region 510 may form the joint 404 between the first segment 402 and the second segment 402.

A width 512 of the overlap region 510 may be defined as a percentage of a total width of the segments 402. For example, a 50% overlap width 512 may position the second lateral edge 504 proximate a center of the upper surface 508 of the first segment 402 whereas a 10% overlap width 512 may position the second lateral edge 504 closer to the first lateral edge 502 than the center of the upper surface 508 of the segment 402. A 50% overlap width 512 may cause the resulting sheet of composite material to have about two plies (e.g., two layers) of composite material due to each segment 402 overlapping half of the proceeding segment 402. The width 512 of the overlap region 510 may be in a range from about 0% (e.g., the butt joint illustrated in FIG. 5A) to about 50%, such as in a range from about 10% to about 50% or from about 10% to about 30%. In some embodiments, the width 512 of the overlap region 510 is defined as a distance independent of the total width of the segments 402. For example, the width 512 of the overlap region 510 may be in a range from about 0 inches (0 cm) to about 5 inches (127 cm), such as from about 1 inch (25.4 cm) to about 3 inches (76.2 cm).

The first segment 402 and the second segment 402 may be secured to one another in the overlap region 510. The first segment 402 and the second segment 402 may be secured to each other through a seaming material 408 extending between the first segment 402 and the second segment 402 in the overlap region 510. As discussed above, the seaming material 408 may be formulated to form bonds with the adjacent material of the segments 402 when heated. For example, when heated, a binder 514 of the seaming material 408 may diffuse into the fibers of the underlying first segment 402 creating an embedded binder 516 (indicated by the dashed line) that is adhered to the fibers of the first segment 402 and the binder 514 of the seaming material 408 may also diffuse into the fibers of the overlying second segment 402 creating an embedded binder 516 that is adhered to the fibers of the second segment 402. The embedded binders 516 effectively bind the fibers of the segments 402 to the seaming material 408 between the segments 402 in the overlap region 510. Thus, the embedded binder 516 on each side of the joint 404 in the overlap region 510 operatively couples the fibers of the segments 402 to each other through the seaming material 408. Coupling the segments 402 across the joint 404 between the segments 402 with the seaming material 408 may facilitate joining the segments 402 when the segments 402 do not include a binder or matrix material, such as when the segments 402 are formed from a dry-fiber material. In some embodiments, one or both sides of segments 402 may already have a resin binder or veil or other seaming material applied that may be activated by the application head 122 or attachment device 126 of application head 122.

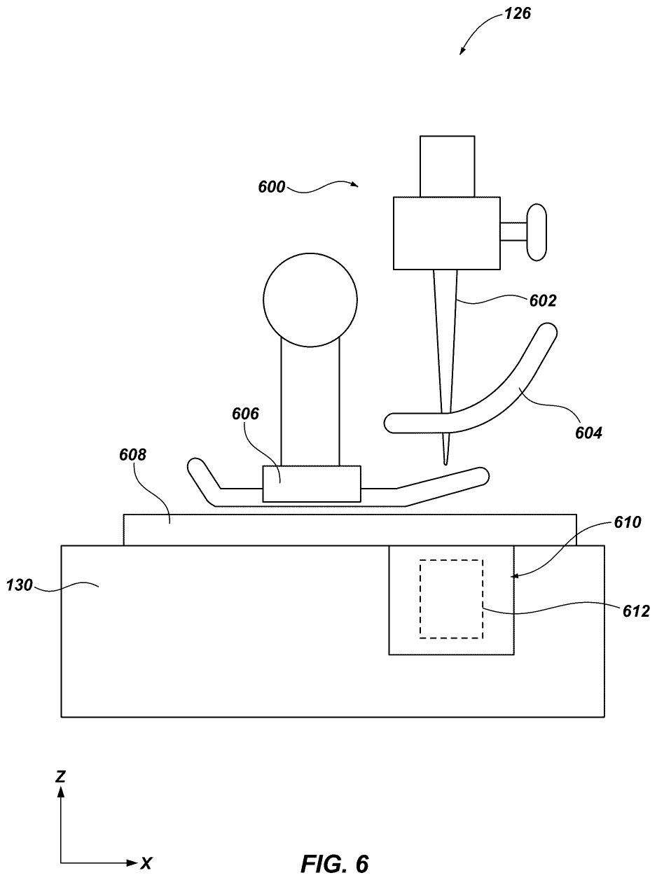

FIG. 6 illustrates another embodiment of the attachment device 126 of the application head 122. The attachment device 126 may be a sewing head 600 (e.g., a stitching head). The sewing head 600 includes a needle 602 configured to receive a fiber 604. The needle 602 is configured to penetrate a fiber material 608 with the fiber 604 to form stitches (e.g., loops of the fiber 604) through the fiber material 608. In some embodiments, the sewing head 600 is configured as a chain-stitch sewing head, configured to use a single fiber 604 passing through the needle 602 to create the stitches though the fiber material 608. In other embodiments, the sewing head 600 is a lock-stitch sewing head, configured to use two fibers 604 one passing through the needle 602 and a second passing through a shuttle 612 beneath the fiber material 608 to create the stitches through the fiber material 608 by looping the two fibers 604 together.

The outlet support structure 130 may include a recess 610 defined beneath the sewing head 600 configured to receive the needle 602. The recess 610 may be a trough or groove extending across the outlet support structure 130. In some embodiments, the recess 610 is configured to move with the feedstock assembly 103, such that the angle of the recess 610 relative to the outlet support structure 130 matches the angle of the feedstock assembly 103. For example, the recess 610 may be a groove or trough that is substantially parallel with the cross travel tracks 128. In embodiments where the sewing head 600 is a lock-stitch sewing head, the shuttle 612 may be positioned in the recess 610. The shuttle 612 may be configured to move along the recess 610 with the sewing head 600.

The sewing head 600 may also include a foot 606. The foot 606 may be configured to apply a pressure to the fiber material 608 holding the fiber material 608 in position as the sewing head 600 moves along the fiber material 608 and the needle 602 forms the stitches in the fiber material 608. In some embodiments, the foot 606 extends the length of the path of the sewing head 600, such that the foot 606 does not move across the fiber material 608 with the sewing head 600. In other embodiments, the foot 606 moves along the surface of the fiber material 608 with the sewing head 600. In other embodiments, the system may include other clamping features configured to hold the fiber material 608 in position, such that the sewing head 600 does not include a foot 606.

As discussed above, the sewing head 600 may be mounted to the application head 122. In other embodiments, the sewing head 600 may be mounted on a robotic head (not shown) configured to operate independently of the application head 122.

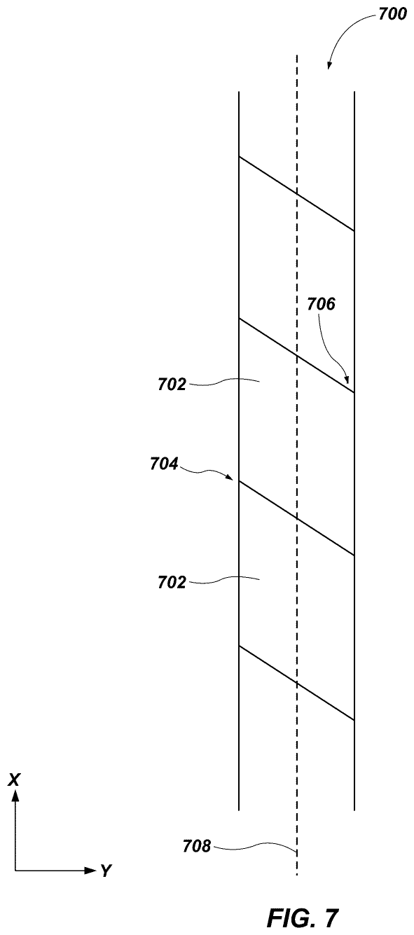

FIG. 7 illustrates a continuous sheet of fiber material 700 that may be formed by the material preparation device 100 (FIG. 1). The continuous sheet of fiber material 700 includes segments 702 joined together at joints 704. As discussed above, the segments 702 are formed from a feedstock material 115 (FIG. 1) that may have a 0° fiber orientation. The segments 702 are formed with the feedstock material 115 (FIG. 1) extending at an angle 706 relative to a material axis 708 of the continuous sheet of fiber material 700. Thus, when the feedstock material 115 (FIG. 1) has a 0° fiber orientation, the fiber orientation of the continuous sheet of fiber material 700 is the angle 706 between the feedstock material 115 (FIG. 1) and the material axis 708.

The segments 702 may be joined together by stitching the edges of the segments 702 together along the joint 704. The edges of the segments 702 may be stitched together using fiber, such as glass fibers, carbon and graphite fibers, basalt fibers, polymeric fibers, including aramide and boron filaments, silica fibers, copper fibers, light threads, comingled resin, structural fibers, and the like. In some embodiments, a stitching machine head or sewing machine head, such as the sewing head 600 (FIG. 6) may be included as part of the material preparation device 100 (FIG. 1).

The stitching along the edges of the segments 702 may join the two adjacent segments 702 together by looping the fiber through both segments 702 along the joint 704. In some embodiments, the fiber used for the stitching is the same material as the fiber in the segments 702. After stitching the segments 702 together along the joint 704, the two segments 702 may form a substantially continuous sheet of fiber material through the joint 704.

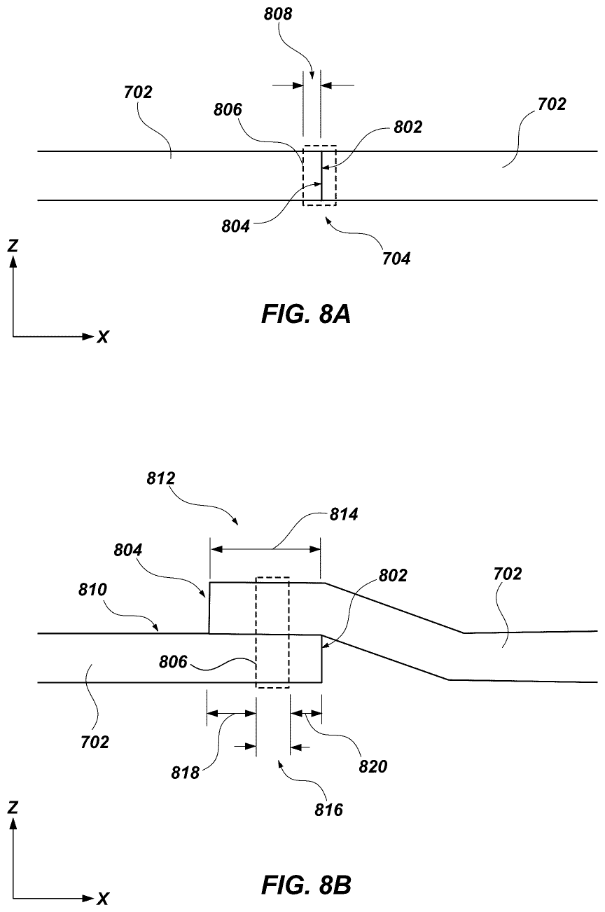

FIGS. 8A and 8B illustrate different embodiments for the joint 704 between adjacent segments 702. In FIGS. 8A and 8B, the dimensions are exaggerated for illustrative purposes. In some embodiments, the joint 704 is a butt joint with no overlap between the adjoining segments 702 as illustrated in FIG. 8A. In other embodiments, the joint 704 is a partially overlapped joint where a portion of the adjoining segments 702 overlap each other at the joint 704 as illustrated in FIG. 8B.

FIG. 8A illustrates a butt joint between two segments 702. At the joint 704 between the two segments 702 a first lateral edge 802 of a first segment 702 abuts a second lateral edge 804 of a second segment 702 with substantially no gap defined between the first lateral edge 802 and the second lateral edge 804. As discussed above, the first segment 702 and the second segment 702 may be joined together by stitches 806 spanning the joint 704 between the two segments 702.

FIG. 8A illustrates a single stitch 806 of the stitches 806. The stitch 806 may be formed from a fiber looping through each of the first segment 702 and the second segment 702 across the joint 704. The fiber may include, without limitation, glass fibers, carbon and graphite fibers, basalt fibers, polymeric fibers, including aramide and boron filaments, silica fibers, copper fibers, light weight threads, comingled resin and structural fibers, and the like.

The stitch 806 extends a distance 808 into each of the first segment 702 and the second segment 702 from the joint 704. The distance 808 may be sufficient to capture at least two fibers of the fiber material in each of the first segment 702 and the second segment 702, such as at least about 4 fibers, at least about 10 fibers, or at least about 20 fibers. For example, the distance may be in a range from about 0.01 in (0.25 mm) to about 4 in (101 mm), such as from about 0.01 in (0.25 mm) to about 2 in (50.8 mm), from about 0.01 in (0.25 mm) to about 1 in (25.4 mm), or from about 0.05 in (1.27 mm) to about 0.5 in (12.7 mm). Coupling the segments 702 across the joint 704 between the segments 702 with the stitches 806 may facilitate joining the segments 702 without a backing material.

FIG. 8B illustrates an overlapping joint between two segments 702. In the embodiment illustrated in FIG. 8B, the second lateral edge 804 extends past the first lateral edge 802, such that the second segment 702 extends over a portion of an upper surface 810 of the first segment 702. An overlap region 812 is defined between the first lateral edge 802 and the second lateral edge 804. The overlap region 812 may form the joint 704 between the first segment 702 and the second segment 702.

A width 814 of the overlap region 812 may be defined as a percentage of a total width of the segments 702. For example, a 50% overlap width 814 may position the second lateral edge 804 proximate a center of the upper surface 810 of the first segment 702 whereas a 10% overlap width 814 may position the second lateral edge 804 closer to the first lateral edge 802 than the center of the upper surface 810 of the segment 702. A 50% overlap width 814 may cause the resulting sheet of composite material to have about two plies (e.g., two layers) of composite material due to each segment 702 overlapping half of the proceeding segment 702. The width 814 of the overlap region 812 may be in a range from about 0% (e.g., the butt joint illustrated in FIG. 8A) to about 50%, such as in a range from about 10% to about 50% or from about 10% to about 30%. In some embodiments, the width 814 of the overlap region 810 is defined as a distance independent of the total width of the segments 702. For example, the width 814 of the overlap region 812 may be in a range from about 0 inches (0 cm) to about 5 inches (127 cm), such as from about 1 inch (25.4 cm) to about 3 inches (76.2 cm).

The first segment 702 and the second segment 702 may be secured to one another in the overlap region 812. The first segment 702 and the second segment 702 may be secured to each other with stitches 806 extending through both the first segment 702 and the second segment 702 in the overlap region 812. Similar to FIG. 8A, FIG. 8B illustrates a single stitch 806. As discussed above, the stitch 806 may be formed from a fiber, such as a glass fiber, a carbon fiber, a graphite fiber, a basalt fiber, a polymeric fiber, including aramide and boron filaments, a silica fiber, a copper fiber and the like. The stitch 806 may form a loop extending vertically (e.g., in a Z-direction) through each of the first segment 702 and the second segment 702 in the overlap region 812. The stitch 806 may define a stitch width 816 that is a distance between the vertically extending fibers in the loop forming the stitch 806. The stitch width 816 may be in a range from about 0.00 in (0.00 mm) to about 0.1 in (2.54) mm, such as from about 0.00 in (0.00 mm) to about 0.075 in (1.9 mm). The stitch 806 may be positioned proximate a center of the overlap region 812. For example, a distance 818 between the stitch 806 and the second lateral edge 804 of the second segment 702 may be substantially the same as a distance 820 between the stitch 806 and the first lateral edge 802 of the first segment 702. The distance 818 and the distance 820 may be sufficient to encompass at least about 2 fibers of the fiber material in the segments 702, such as at least about 10 fibers or at least about 20 fibers. For example, the distances 818, 820 may be in a range from about 0.1 mm to about 1 mm, such as from about 0.2 mm to about 0.8 mm. The stitches 806 effectively bind the fibers of the segments 702 together in the overlap region 812. Thus, the stitches 806 extending through both segments 702 at the joint 704 in the overlap region 812 operatively couple the fibers of the segments 702 to each other. Coupling the segments 702 across the joint 704 between the segments 702 with the stitches 806 may facilitate joining the segments 702 when the segments 702 do not include a binder or matrix material, such as when the segments 702 are formed from a dry-fiber material.

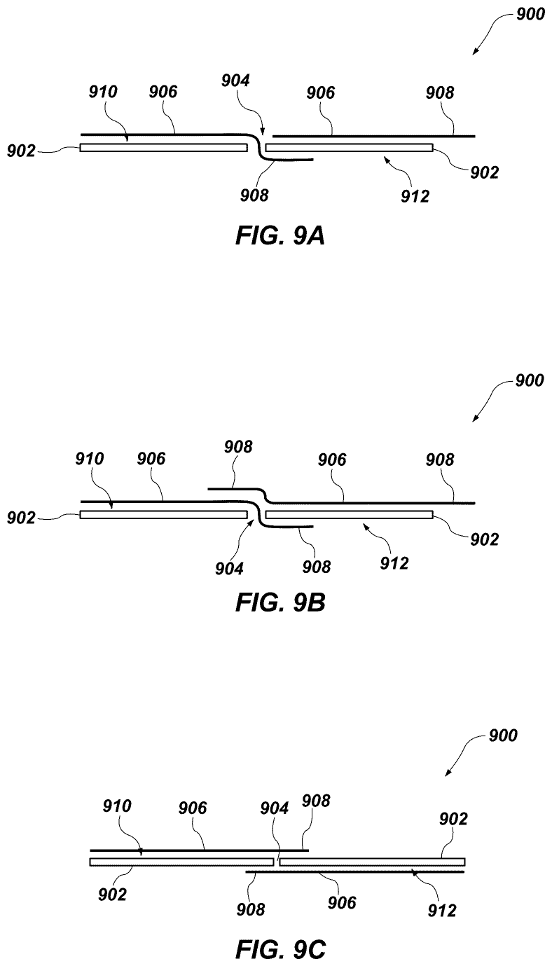

FIGS. 9A-9C illustrate a continuous sheet of fiber material 900 that may be formed by the material preparation device 100 (FIG. 1). The continuous sheet of fiber material 900 includes segments 902 joined together at joints 904. In the embodiments illustrated in FIGS. 9A-9C, the segments 902 each include a seaming material 906 extending across the segments 902 with an overlap 908 extending beyond the lateral area of each individual segment 902. In some embodiments, the seaming material 906 is applied after the segment 902 is separated from the feedstock material 115. In other embodiments, the feedstock material 115 includes the seaming material 906 positioned over a surface of the feedstock material 115 similar to a backing material. In some embodiments, the seaming material 906 extends over an entire lateral area of the segments 902. In other embodiments, the seaming material 906 may be formed from thin strips extending laterally over portions of each segment 902, while other portions of the same segment are substantially free of the seaming material 906.

The segments 902 may be joined together by the overlap 908 of the seaming material 906 extending across the joint 904. As discussed above, the seaming material 906 may be a fiber reinforced material, such as a low areal weight fiber with binder or resin veil, an unreinforced resin veil material, comingled resin and fiber filaments, or other binder compatible with the dry material format. The seaming material 906 may be configured to form bonds with the underlying material of the segments 902. For example, when heated, the binder in the seaming material 906 may diffuse into the fibers of the underlying segments 902 bonding the segments 902 to the seaming material 906 on both sides of the joint 904. The seaming material 906 may be heated with a heating element configured to apply heat and pressure to the seaming material 906, such as the heating element 316 illustrated in the manufacturing head 300 of FIG. 3.

FIG. 9A illustrates an embodiment of the continuous sheet of fiber material 900 where each segment 902 includes the seaming material 906 with an overlap 908 extending from one lateral side of the segment 902. In the embodiment illustrated in FIG. 9A, the overlap 908 extends from an upper surface 910 of the first segment 902 through the joint 904 and under the lower surface 912 of the next segment 902. The seaming material 906 may be cured to form bonds between the seaming material 906 and the upper surface 910 of the first segment 902 and bonds between the seaming material 906 and the lower surface 912 of the next segment 902 joining the two segments 902 together across the joint 904 to form a single continuous sheet of fiber material 900.

FIG. 9B illustrates an embodiment of the continuous sheet of fiber material 900 where each segment 902 includes the seaming material 906 with an overlap 908 extending from both lateral sides of the segment 902. In the embodiment illustrated in FIG. 9B, the overlap 908 from the seaming material 906 of the first segment 902 extends from an upper surface 910 of the first segment 902 through the joint 904 and under the lower surface 912 of the next segment 902. The seaming material 906 from the next segment 902 extends from the upper surface 910 of the next segment 902 over the upper surface 910 of the first segment 902. The seaming material 906 may be cured to form bonds between the seaming material 906 and the upper surfaces 910 of the first segment 902 and the next segment 902 as well as bonds between the seaming material 906 of the first segment 902 and the lower surface 912 of the next segment 902 joining the two segments 902 together across the joint 904 to form a single continuous sheet of fiber material 900.

FIG. 9C illustrates an embodiment of the continuous sheet of fiber material 900 where each segment 902 includes the seaming material 906 with an overlap 908 extending from both lateral sides of the segment 902. In the embodiment illustrated in FIG. 9C, every other segment 902 is vertically inverted, such that the overlap 908 from the seaming material 906 of the first segment 902 extends from an upper surface 910 of the first segment 902 across the joint 904 and over the upper surface 910 of the next segment 902, while the seaming material 906 from the next segment 902 extends from the lower surface 912 of the next segment 902 across the joint 904 and under the lower surface 912 of the first segment 902. The seaming material 906 may be cured to form bonds between the seaming material 906 and the upper surfaces 910 of the first segment 902 and the next segment 902 as well as bonds between the seaming material 906 the lower surfaces 912 of the first segment 902 and the next segment 902, joining the two segments 902 together across the joint 904 to form a single continuous sheet of fiber material 900.

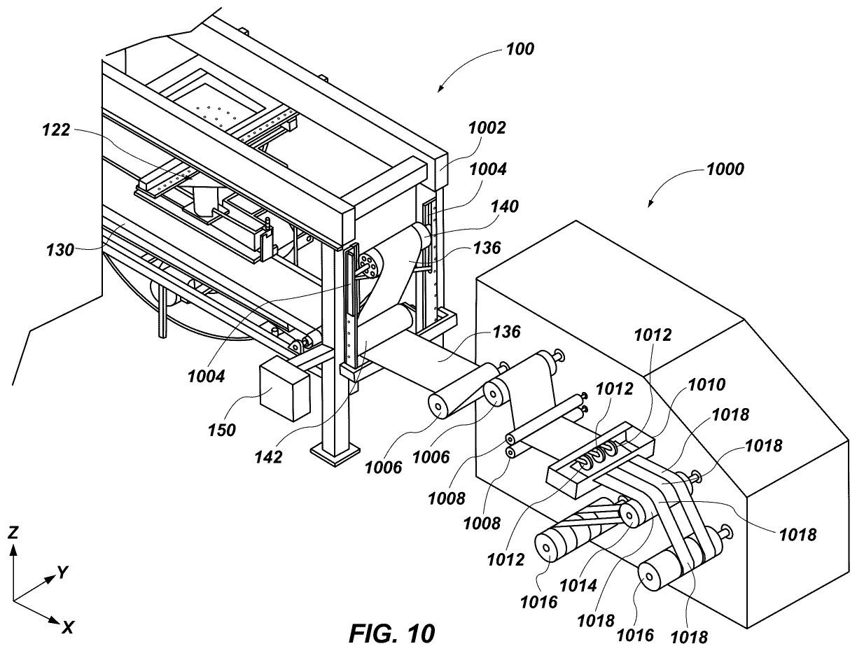

FIG. 10 illustrates an embodiment of a material preparation device 100 coupled to a slitter assembly 1000. The material preparation device 100 may be secured within a frame 1002 configured to position the material preparation device 100 relative to the slitter assembly 1000. The frame 1002 is configured to position the rollers 140 and output material gathering assembly 142 of the material preparation device 100 in a manner configured to transmit the output material 136 (e.g., the continuous fiber material, continuous bias ply material) prepared by the material preparation device 100 from the outlet support structure 130 to the slitter assembly 1000. The frame 1002 may include tracks 1004 configured to move one or more of the rollers 140 and the output material gathering assembly 142 vertically (e.g., in the Z-direction) relative to the outlet support structure 130. Changing the vertical position of the rollers 140 or the output material gathering assembly 142 may facilitate changing a tension in the output material 136.

The slitter assembly 1000 may be controlled by the controller 150 of the material preparation device 100. The slitter assembly 1000 may be configured to be coupled to the frame 1002, such that the position of the slitter assembly 1000 relative to the material preparation device 100 is fixed by the frame 1002. As illustrated in FIG. 10, the slitter assembly 1000 is substantially aligned with the outlet support structure 130, such that the output material 136 travels in a substantially straight path in the X-direction from the material preparation device 100 to the slitter assembly 1000.

The slitter assembly 1000 is used to cut the output material 136 into two or more strips of continuous fiber material 1018 in select widths for a particular application. The slitter assembly 1000 illustrated in FIG. 10 includes redirect rollers 1006 that redirect the output material 136 from the output material gathering assembly 142 of the material preparation device 100. The output material 136 passes then through nip rollers 1008 and into knife holder 1010. The knife holder 1010 holds a plurality of knives 1012 that may be selectively positioned to cut the output material 136 into as many strips as desired having select widths. The knives 1012 may include shear, crash, laser, or razor type knives. In the embodiment illustrated in FIG. 10, three knives 1012 are used to cut the output material 136 into four strips of continuous fiber material 1018. Redirect roller 1014 is configured to maintain the individual strips of continuous fiber material 1018 in a substantially flat orientation as the strips of continuous fiber material 1018 leave the knife holder 1010. The strips of continuous fiber material 1018 are then redirected to collection rollers 1016. The strips of continuous fiber material 1018 are collected on the collection rollers 1016. Thus, the slitter assembly 1000 separates the output material 136 into strips of continuous fiber material 1018 that can be used to accommodate specific applications.

The output material 136 and/or strips of continuous fiber material 1018 may be used to form composite structures, such as components of a vehicle, such as an automobile, an aircraft, or a space craft. For example, the strips of continuous fiber material 1018 may be used to form thin composite support structures, such as stringers to support the vehicle structures, such as an airframe, unibody frame, or casings. In other embodiments, the output material 136 may be used to form larger composite structures, such as engine cases, body panels, casing structures, wing surfaces, etc. The output material 136 and/or strips of continuous fiber material 1018 may be applied by automated machinery, such as robotic application heads, or other design specific automated machinery. The automated machinery may be configured to select output material 136 and/or strips of continuous fiber material 1018 having the desired fiber orientation for each ply of the associated composite structure. For example, a single composite structure may be formed from multiple plies of fiber material each having different fiber orientations. Therefore, the automated machinery may select different output materials 136 or strips of continuous fiber materials 1018 for each ply of an associated composite structure. In some embodiments, multiple layers of fiber at different orientations may be generated by material preparation machine 100, using multiple material application stations positioned along the material takeup station axis, or by passing the material through a single application system multiple times and binding the multiple layers together, then slitting the multi-layer material format into multiple roll widths.

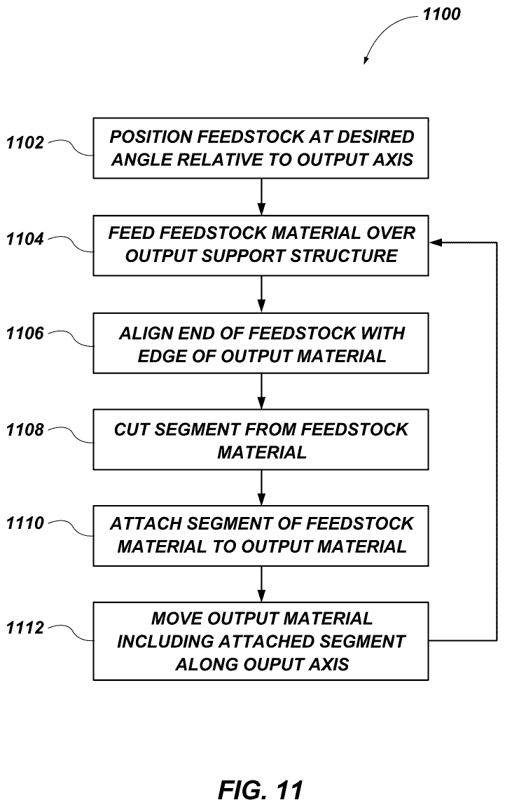

FIG. 11 illustrates a flow chart representative of a method 1100 of forming a continuous sheet of fiber material (e.g., a continuous sheet of bias ply material), such as the continuous sheets of fiber material 400, 700. The method 1100 is directed to forming the continuous sheet of fiber material from a feedstock material. As discussed above, the feedstock material may be a uni-directional fabric or tape or 0/90 fabric material. The unidirectional feedstock material may include fibers oriented at 0° to an edge of material. The feedstock material may or may not include a backing material.

The feedstock material is positioned at a desired fiber orientation angle relative to an output axis of the continuous sheet of fiber material in act 1102. Positioning the feedstock material at the desired fiber orientation angle may result in the 0° fibers extending at the desired fiber orientation angle relative to the output axis of the continuous sheet of fiber material. The desired fiber orientation angle may be in a range from about 10° to about 170°, such as 30°, 45°, 60°, 90°, 120°, 135°, and 130°.

The feedstock material is fed over an output support structure (e.g., outlet support structure 130) in act 1104. The feedstock material may be fed over the output support structure until an end of the feedstock material is aligned with a distal edge of the output material in act 1106. Thus, the feedstock material may be fed across the area defining the width of the output material.

Once the feedstock material is fed over the output support structure and aligned with the distal edge of the output material, the feedstock material is cut to form a segment from the feedstock material in act 1108. The feedstock material may be cut in a position substantially aligned with the proximal edge of the output material, such that the segment has a same width as the output material. The edges of the segment may be substantially aligned with the associated edges of the output material.

The segment of the feedstock material is attached to the output material along a joint between the segment and the output material in act 1110. In some embodiments, the segment of the feedstock material is attached to the output material before the segment is cut from the feedstock material in act 1108. In other embodiments, the segment of feedstock material is attached to the output material after the segment is cut from the feedstock material in act 1108. As discussed above, the segment of the feedstock material may be attached to the output material through multiple different processes.

In some embodiments, the segment of the feedstock material is attached to the output material through a seaming material (e.g., seaming material 302, 408). The tape material may include fiber material in a binder material. After the tape material is applied over the joint between the segment and the output material, heat and pressure is applied to the tape material. The heat and pressure may cause the binder material to diffuse into the fibers of the segment and the output material binding the segment and the output material to the tape material. The tape material thus effectively attaches the segment to the output material forming a continuous sheet of fiber material.

In other embodiments, the segment of the feedstock material is attached to the output material through a stitching or sewing process. The stitches formed during the stitching or sewing process may be formed from fibers, such as fibers of the same material as the fibers in the feedstock material. The stitches loop through the fibers of the segment and the fibers of the output material across the joint between the segment and the output material. Thus, the stitches effectively attach the segment to the output material forming a continuous sheet of fiber material.

In some embodiments, the segment of the feedstock material is attached to the output material through both a stitching or sewing process and by a tape material. For example, the segment of the feedstock material may be attached to the output material through a stitching process and a tape material may be applied over the joint after the stitching process. The tape material may then be heated to diffuse the binder material into the underlying fiber materials, such that the segment of the feedstock material is attached to the output material through both stitching and the tape material further strengthening the joint between the segment of the feedstock material and the output material.

The fibers in the segment are substantially parallel with the fibers in the output material. As discussed above, the fibers in the segment are oriented at the same angle relative to the axis of the output material as the angle between the feedstock and the axis of the output material. Thus, attaching the segment to the output material forms a continuous sheet of fiber material having the fibers oriented at the desired fiber orientation angle relative to the axis of the output material.

After the segment is attached to the output material and cut from the feedstock material, the output material is moved along the output axis until the output material including the newly attached segment is clear of the area where the feedstock material is fed over the output support structure in act 1112. After the output material is moved out of the area where the feedstock material is fed over the output support structure, a new segment of the feedstock material is fed over the output support structure in act 1104 and the acts 1106, 1108, 1110, 1112 are repeated attaching another segment of the feedstock material to the output material in substantially the same orientation as the previous segment. Thus, as each segment is added to the output material, the output material forms a continuous sheet of fiber material, having the fibers oriented at the desired angle relative to the axis of the output material.

As discussed above, with respect to FIG. 10, the continuous sheet of fiber material may go through an additional slitting process to form thinner strips of continuous fiber materials. For example, after the continuous sheet of fiber material is formed the continuous sheet of fiber material may be split into two or more strips of continuous fiber in a slitter assembly. The slitting process may be used to form strips of continuous fiber material configured to form composite structures that are narrower than the continuous sheet of fiber material while reducing scrap.

Embodiments of the disclosure facilitate joining segments of fiber material together to form a continuous sheet of fiber material having a desired fiber orientation (e.g., bias ply fiber materials). Joining segments of material at desired orientation in accordance with the embodiments of the disclosure may facilitate forming continuous sheets of fiber material without a backing material. For example, dry-fiber sheets that do not conventionally include a backing material may be joined together to form a continuous sheet of dry-fiber material having different fiber orientation angles than the manufactured rolls of dry-fiber material (e.g., an off-axis roll of dry fiber material).

Forming continuous sheets of fiber material with desired fiber orientation angles facilitates greater efficiency when forming composite structures where multiple different fiber orientation angles are used to form the different layers of composite material within the composite structure. Furthermore, forming custom widths of continuous sheets of fiber material with the desired fiber orientation angles reduces waste or scrap produced when forming the associated composite structures. Reducing scrap and improving the efficiency of forming composite structures may reduce the costs associated with forming the composite structures, which may similarly reduce the costs of forming the composite structure.

The embodiments of the disclosure described above and illustrated in the accompanying drawing figures do not limit the scope of the invention, since these embodiments are merely examples of embodiments of the invention, which is defined by the appended claims and their legal equivalents. Any equivalent embodiments are intended to be within the scope of this disclosure. Indeed, various modifications of the disclosure, in addition to those shown and described herein, such as alternative useful combinations of the elements described, may become apparent to those skilled in the art from the description. Such modifications and embodiments are also intended to fall within the scope of the appended claims and their legal equivalents.

What is claimed is:

1. A continuous sheet of fiber material comprising:
a first segment of fiber material;
a second segment of fiber material;
a joint between the first segment of fiber material and the second segment of fiber material; and
a seaming material extending across the joint between the first segment of fiber material and the second segment of fiber material, the seaming material including a binder material, the binder material at least partially embedded into fibers of the first segment of fiber material and the second segment of fiber material.

2. The continuous sheet of claim 1, wherein the joint between the first segment of fiber material and the second segment of fiber material is substantially parallel with fibers in each of the first segment of fiber material and the second segment of fiber material.

3. The continuous sheet of claim 1, wherein fibers in the first segment of fiber material and the second set of fiber material are unidirectional.

4. The continuous sheet of claim 3, wherein the fibers in the first segment of fiber material and the second segment of fiber material extend at a fiber angle in a range from about 10° to about 170° relative to a longitudinal axis of the continuous sheet of fiber material.

5. The continuous sheet of claim 1, wherein the joint between the first segment of fiber material and the second segment of fiber material comprises a butt joint.

6. The continuous sheet of claim 5, wherein the seaming material extends across the butt joint and over a portion of each of the first segment of fiber material and the second segment of fiber material on opposing sides of the butt joint.

7. The continuous sheet of claim 1, wherein the joint between the first segment of fiber material and the second segment of fiber material comprises an overlapping joint.

8. The continuous sheet of claim 7, wherein the seaming material extends between the first segment of fiber material and the second segment of fiber material in an overlapping region of the overlapping joint.

9. A continuous sheet of dry-fiber comprising:
a first segment of dry-fiber material including a first plurality of fibers;
a second segment of dry-fiber material including a second plurality of fibers;
a joint between the first segment of dry-fiber material and the second segment of dry-fiber material, the joint substantially parallel with the first plurality of fibers in the first segment of dry-fiber material and the second plurality of fibers in the second segment of dry-fiber material; and
stitches extending across the joint between the first segment of dry-fiber material and the second segment of dry-fiber material, the stitches formed from at least one fiber, each stitch of the stitches extending in a direction substantially perpendicular to the joint.

10. The continuous sheet of claim 9, wherein each stitch of the stitches comprises a loop of the at least one fiber.

11. The continuous sheet of claim 10, wherein the loop of the at least one fiber extends through both the first segment of dry-fiber material and the second segment of dry-fiber material.

12. The continuous sheet of claim 10, wherein the loop of the at least one fiber encompasses at least two fibers of the first plurality of fibers in the first segment of dry-fiber material and at least two fibers of the second plurality of fibers in the second segment of dry-fiber material.

13. The continuous sheet of claim 10, wherein the loop of the at least one fiber defines a stitch width in a range from about 0.2 mm to about 2 mm.

14. The continuous sheet of claim 9, wherein the joint between the first segment of dry-fiber material and the second segment of dry-fiber material comprises a butt joint.

15. The continuous sheet of claim 14, wherein the stitches extend across the butt joint and vertically through each of the first segment of dry-fiber material and the second segment of dry-fiber material on opposing sides of the butt joint.

16. The continuous sheet of claim 9, wherein the joint between the first segment of dry-fiber material and the second segment of dry-fiber material comprises an overlapping joint.

17. The continuous sheet of claim 16, wherein the stitches extend vertically through each of the first segment of dry-fiber material and the second segment of dry-fiber material in an overlapping region of the overlapping joint.

18. A method of forming a continuous sheet of fiber material comprising:
positioning a feedstock material having no backing material at an angle relative to an output axis;
cutting a segment of the feedstock material; and
attaching the segment of the feedstock material to an output material at the angle relative to the output axis, the output material having no backing material.

19. The method of claim 18, wherein attaching the segment of feedstock material to the output material comprises:
applying a seaming material to a joint between the segment of feedstock material and the output material, the seaming material in contact with both the segment of feedstock material and the output material across the joint;
applying heat and pressure to the seaming material; and
diffusing a binder material of the seaming material into fibers of the segment of feedstock material and fibers of the output material.

20. The method of claim 18, wherein attaching the segment of feedstock material to the output material comprises stitching the segment of feedstock material to the output material with loops of fiber extending across a joint between the segment of feedstock material and the output material.
